(19) United States
(12) Patent Application Publication
(10) Pub. No.: US 2009/0041300 A1
(43) Pub. Date: Feb. 12, 2009

(54) HEADLIGHT SYSTEM FOR VEHICLES, PREFERABLY FOR MOTOR VEHICLES

(75) Inventor: Bernd Mack, Remshalden (DE)

Correspondence Address: REISING, ETHINGTON, BARNES, KISSELLE, P.C., P O BOX 4390, TROY, MI, 48099-4390, US

(73) Assignee: SCHEFENACKER VISION SYSTEMS GERMANY GMBH, Schwaikheim (DE)

(21) Appl. No.: 11/873,501

(22) Filed: Oct. 17, 2007

(30) Foreign Application Priority Data
Oct. 18, 2006 (DE) 10 2006 050 236.1

(51) Int. Cl. G06K 9/62

(52) U.S. Cl. 382/103

(57) ABSTRACT

1. Headlight system for vehicles, preferably for motor vehicles

2.1 The headlight system has an adjustable headlight and a device to record the road layout. The device has an imaging sensor with an image processing device and a control device and sends signals [concerning] the images/data determined via the imaging sensors by means of the image processing device and to the control device to actuators or lamps of the headlight to change the direction of the emitting beam [sic].

2.2 In order for any change in direction of the emitting beams to occur already before the change in direction, the image processing device generates a signal from the images/data determined by the imaging sensor, which permits prediction of the road layout and which is fed to the light control device. It sends signals to the actuators for an anticipatory direction change of the light beams of the headlight.

2.3 Such a headlight system is used in motor vehicles.

The invention concerns a headlight system for vehicles, preferably for motor vehicles according to the preamble of Claim 1.

Headlight systems for vehicles are known in which the headlights follow a direction change (for example when driving around a curve) with corresponding illumination area. This co-steering can be coupled and therefore driven by a mechanical connection (cable pull system) between the steering or other pivoting components when traveling around a curve.

Such a system only functions when the driver steers into a curve or turns in another direction from his lane. In such systems the co-steering of the headlight is coupled via geometric steering parameters to the steering and functions at the same time as the steering process. All these systems have a true predictive behavior.

Systems are also conceivable that are supported by navigation systems with GPS.

The determined data are compared with data of street maps that are entered in the present navigation systems. Current position data can also be evaluated via a GPS satellite system. Coupling between pure mechanical information of the moving vehicle with entered map material data as well as actual determined data via GPS satellite systems make it possible to co-steer the headlights according to the desired direction change simultaneously or in anticipation during turning or traveling around a curve. Current map material is necessary. Difficulties occur abroad, since map material is often lacking or small streets are not marked. On many trips in the immediate vicinity, for example, on the way to work, shopping and the like, no navigation system is used; the system then does not know what the destination is. Driving in anticipation is therefore not possible with the systems.

Such headlight systems are best suited for simultaneous pivoting of the headlights during traveling around the curve. Simpler and older systems often react with a time offset so that pivoting of the headlights only occurs already when steering into a curve or when turning has been initiated.

Moreover, other systems are known in which the roadway and therefore the travel direction are detected via a sensor. Examples of such systems are adaptive cruise control systems. Studies on optical lane-holding systems are also known.

The purpose of these systems in the case of adaptive cruise control systems is to maintain a minimum distance to a vehicle traveling in front, or in the case of lane-holding systems to warn the driver before he leaves his lane.

The underlying task of the invention is to design the generic headlight system so that even before the direction change or direction alteration pivoting of the headlights can occur accordingly.

This task is solved in the generic headlight system according to the invention with the characterizing features of Claim 1.

In the headlight system according to the invention a prediction of the road layout is achieved without using GPS data or map material data. The imaging sensor determines images/data of the surroundings. From these data the image processing device determines the street layout in front of the vehicle and the presumed further travel motion of the vehicle by means of additional vehicle-specific information, for example, the speed of the vehicle. The light beams can be adjusted accordingly. For example, before a change in travel direction arrives or is initiated, the illumination area in front of the vehicle is adjusted according to this change in travel direction. For this purpose a direction of speed factor is determined, which records the area in front of the vehicle via an optical system and therefore identifies whether a direction change is to be expected or is not imminent. These environment-specific images/data are linked to vehicle data, like vehicle speed, set travel direction displays and possibly steering values. From the environmental images/data and these vehicle data, signals are generated with which an anticipatory direction change of the emitting light beams in the headlight is possible. Predictive assumptions are additionally made; for example, a speed reduction before a street intersection recognized by an image processing unit means a desire of the driver to turn or the desire to get his bearings or inspect a hazard site. Broader illumination is necessary. Additional information, like setting of the travel direction display, recognition of steering movements or recognition of only a possible turning direction, among other things, specify the assumptions concerning the driver's wish.

By means of optically recorded environmental data the headlight system can identify objects on the edge of the roadway or roadway markings. The objects can be prominent objects that establish the system as statically defined objects. By a number of detected images of the street layouts situated in front of the vehicle as well as its direct edge surroundings changes of static objects are made possible. This system therefore recognizes whether a curve or turn or intersection is to be expected during continuing travel. In particular, by linking these environmental data with the vehicle data an anticipatory direction change and therefore a corresponding headlight control is reliably guaranteed.

The static objects (prominent objects) on the edges of the roadway can be determined in their position and coordinate change during travel of the vehicle so that the system can establish differences in their evaluation and can define vectors according to these differences as motion or also speed vectors. Should the road layout to be expected vary to one side, the system will identify in all prominent objects, for example, the roadway edge or prominent objects, a continuous lateral change and therefore establish a motion vector. According to the travel speed of the vehicle, the size and length of this vector therefore also changes, with which the parameters of speed during travel direction changes to be expected, especially strong travel direction changes, like intersections or turns, can also be determined.

Through such an anticipatory system that operates independently of stored data, like street maps or actual satellite data, a continuous illumination adjustment during travel is possible. This continuous illumination adjustment changes the illumination area of the headlights advantageously in stepless fashion according to the stipulated direction changes and/or speed of the vehicle.

Naturally the mentioned stored data can be used as a support; however, they are not absolutely essential for the headlight system according to the invention.

During slow travel the illumination range can therefore be advantageously reduced and the illumination of the side areas in front of the vehicle increased. During fast travel the illumination of the vehicle in the front lateral area can be reduced, whereas the illumination can be aligned farther ahead in the travel direction. During fast travel through a curve illumination far forward is advantageous, in which a lateral widening of the illumination area occurs according to the curvature of the change in direction of travel.

Even in a standing vehicle this state is recognized; the illumination area will then correspond instead to a surrounding and position illumination.

The illumination can occur stepless or in finely graded steps.

For the possible situations of the forward and lateral illumination areas typical maps or relative calculation formulas can be entered in the control system. All additional parameters or experience values can be entered in such controls and systems as a binary code in memories so that a corresponding illumination can be determined at any time.

Another variant consists of the fact that such a system can be programmed quasi-intelligently, in which the system is capable of identifying the driving behavior of a driver and the characteristics entered in the memory can be made available for calculation of correspondingly adapted illumination areas. Such an individual adaptation can occur continuously, which has the major advantage that, depending on the traffic situation or conditional capabilities of the driver, corresponding illuminations can be adapted.

Additional features of the invention are apparent from the additional claims, the description and the drawings.

The invention is further explained by means of practical examples depicted in the drawings. In the drawings

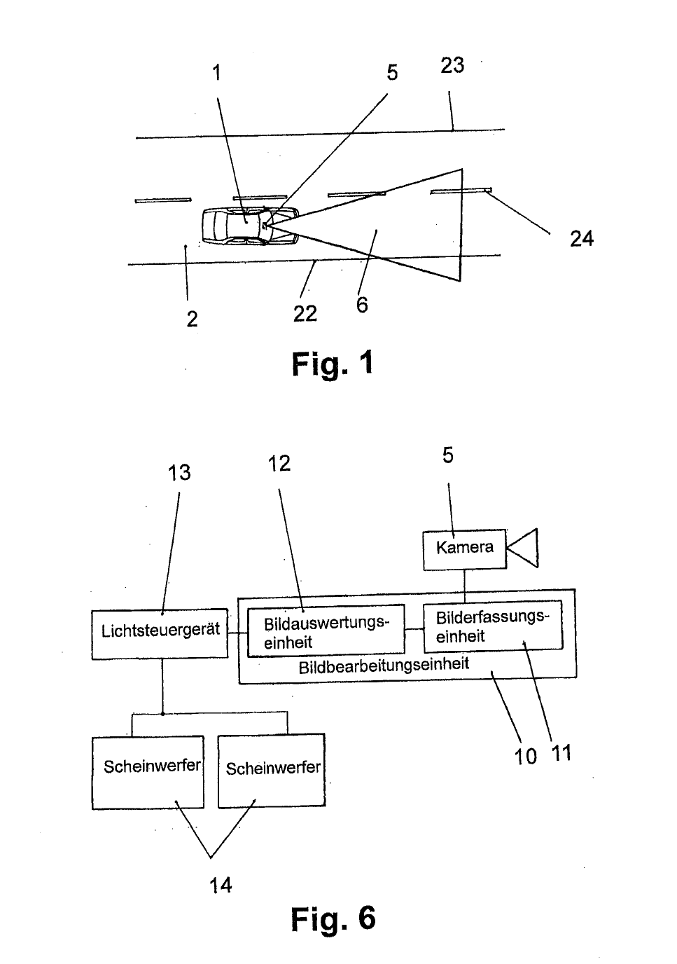

FIG. 1 shows in a top view and in a schematized representation a front camera recording area of a vehicle driving on a street,

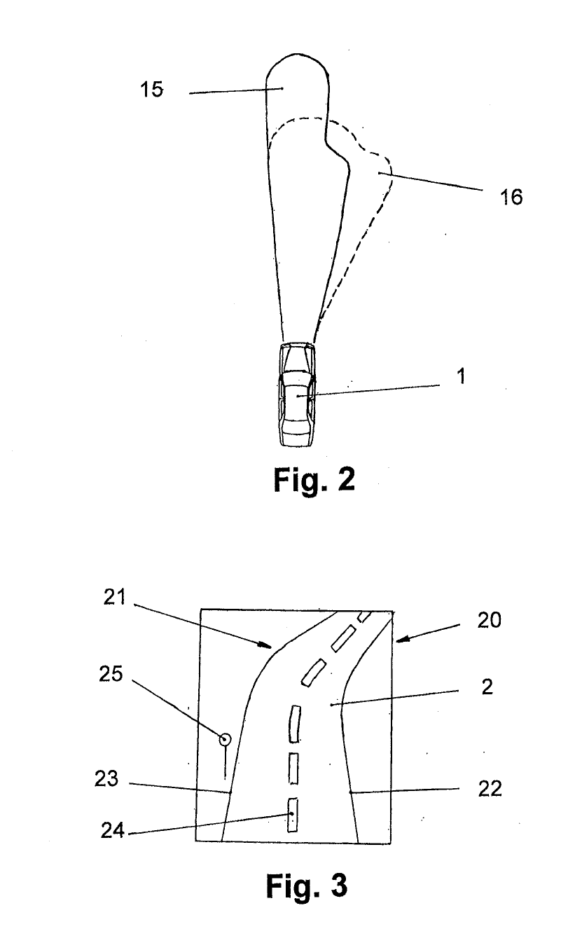

FIG. 2 shows a schematic top view of two front headlight illumination areas of the vehicle,

FIG. 3 shows a static camera image with prominent contours/geometries for image processing,

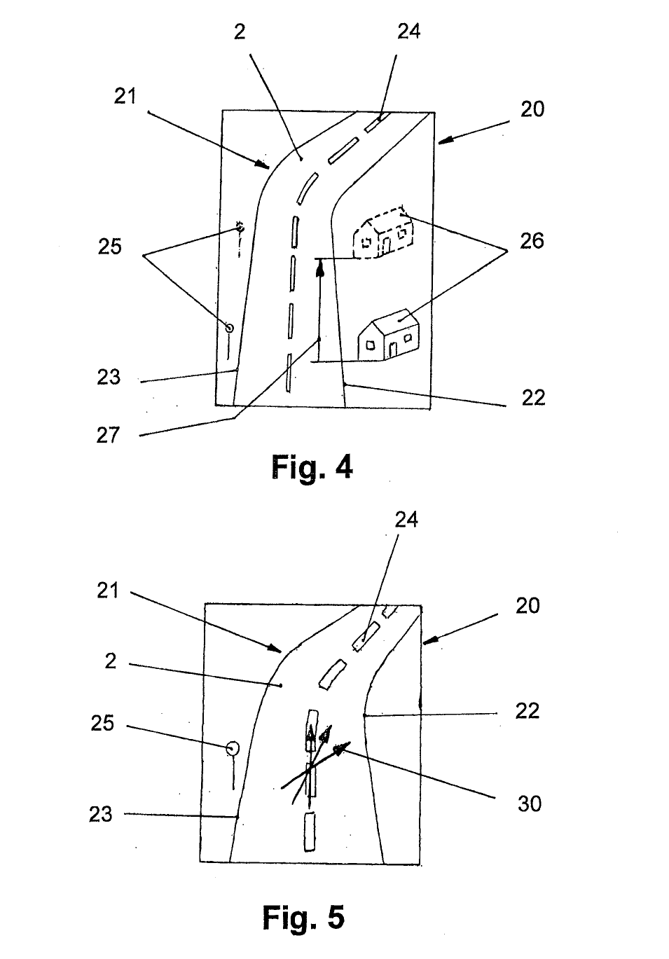

FIG. 4 shows a dynamic camera image with prominent moving contours/geometries for image processing,

FIG. 5 shows a camera image with movement vectors for a change in direction,

FIG. 6 shows a simplified representation of a headlight system according to the invention in the form of a block diagram of image recording up to adjustment of the headlight,

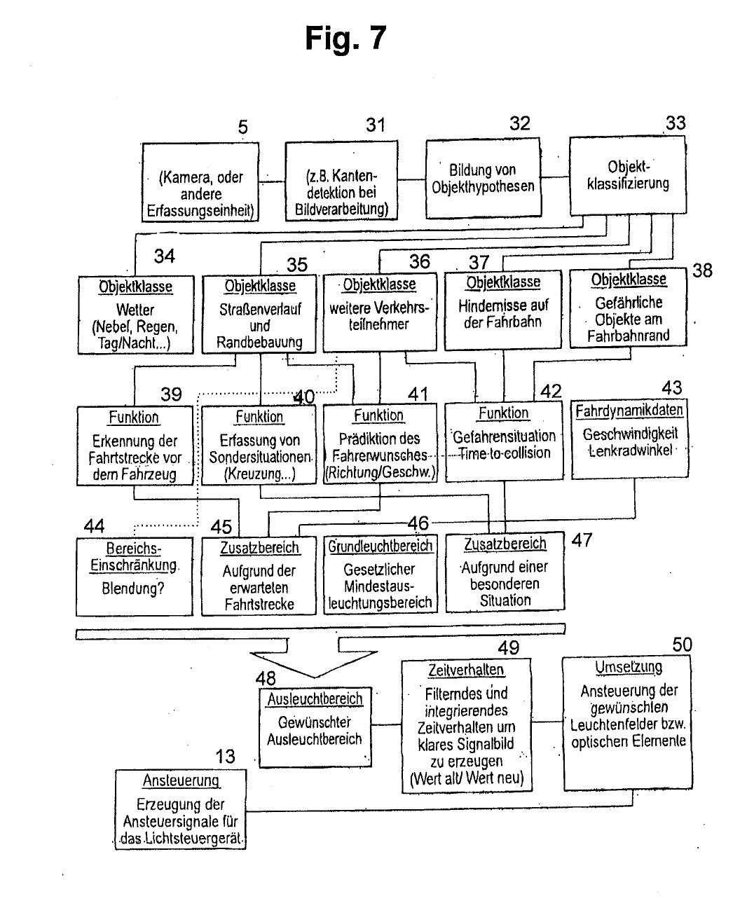

FIG. 7 shows a flow chart with dependences to influence the camera image recording up to control of the headlight,

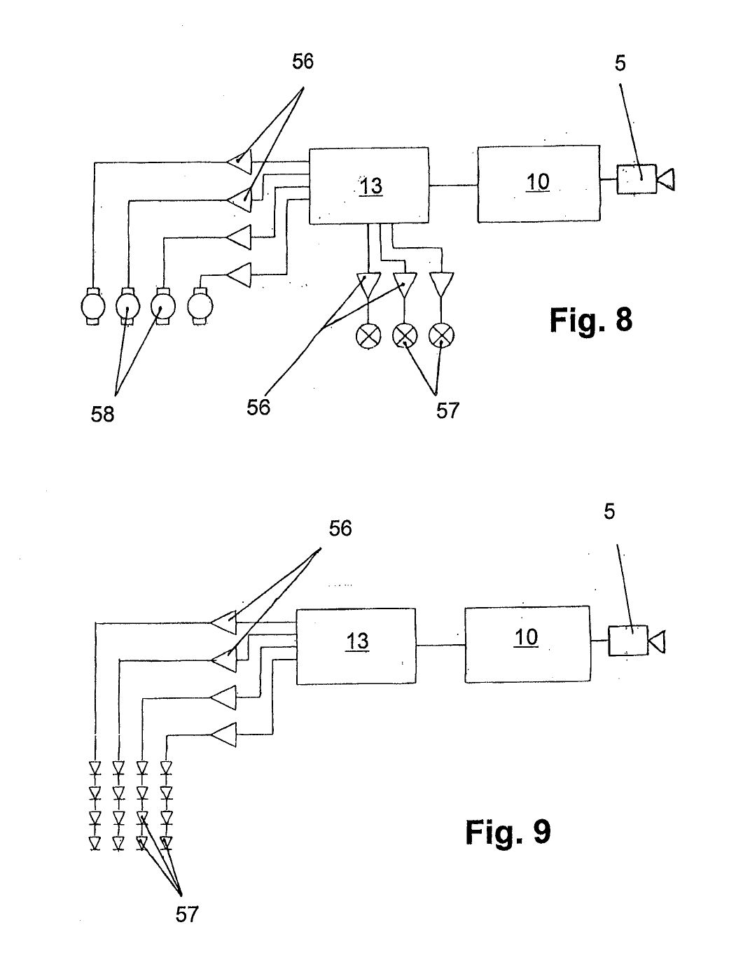

FIG. 8 shows control of actuators/servo elements for mechanical adjustment of headlights,

FIG. 9 shows control of lamps in a headlight,

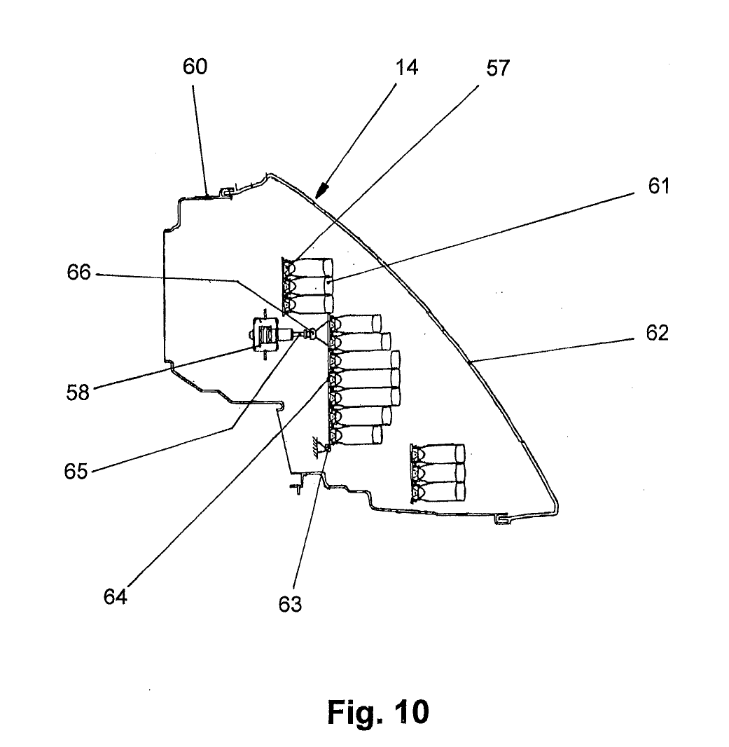

FIG. 10 shows a schematic top view of a headlight with pivot drive.

FIG. 1 shows a top view of a front camera recording area 6 of a vehicle 1 driving on a street 2. Here an optical camera 5 is situated in the upper center area of the windshield of vehicle 1. This camera 5 can be situated behind the windshield and advantageously in the area of the rear view mirror inside the vehicle. The camera 5 can also be positioned in the roof edge area between the roof and windshield or in the area of an A pillar of the vehicle 1.

The optical recording area 6 of the camera 5, as shown in FIG. 1, is essentially aligned only on the area of street 2 situated in front of vehicle 1 so that only the right and left roadway edge 22, 23 as well as the area situated in the center in front of the vehicle 1 or the middle roadway marking 24 are recorded by camera 5. The camera 5 is preferably designed so that it can record obstacles on the roadway that are larger than about 5 cm.

In an enlarged recording area 6 an area of the street 2 extending farther forward, as well as the immediate street surroundings, are recorded. In this case not only the right roadway edge 22 and the middle roadway marking 24 are recorded, but also the left roadway edge 23, as well as prominent contours or geometries 25, 26 that are situated in the immediate recording area of the right or left street edge 22, 23. The camera 5 is advantageously designed so that it can record edge structures of the street that are larger than about 40 cm.

FIG. 2 shows in a top view two front illumination areas 15, 16 of a vehicle 1. Illumination area 15 represents the illumination during straight travel of vehicle 1. According to the travel speed of vehicle 1 this illumination area 15 for straight travel will be projected variably in extent of the illumination in front of vehicle 1. With increasing or higher speed the illumination area 15 extending in front of vehicle 1 is increased. During slower travel or during anticipated turns or curved travel, depending on the speed, the illumination area 15, 16 is changed in its shape and/or illumination range (extent). For example, during a right curve or right turn the illumination area 16 for the right street edge 22 is enlarged according to the curve (turn) being traveled to this side. Since the speeds of the vehicle are reduced during curved travel or turns, the illumination area 15 for straight travel can be shortened accordingly.

FIG. 3 shows a schematic view of the camera image 20. In this figure the street edges are imaged as prominent contours/geometries as left and right street edge 22, 23. As an additional prominent feature, a traffic sign 25 is imaged laterally on the left street edge 23. In the example depicted here the street layout 21 is shown bending rightward in the upper part of camera image 20.

The image in FIG. 3 corresponds to an instantaneous image produced by the camera 5 situated in vehicle 1. For evaluation in image recording unit 11 (FIG. 6) only the prominent contours are recorded as edges by this camera image 20 so that a pure edge image is formed. This is necessary for further processing in an image processing unit 10, since only brightness jumps with corresponding different contrasts can be evaluated to record prominent contours.

A camera image 20 with a street 2 and prominent objects 25, 26 in the edge area of the street are imaged in FIG. 4. It is very apparent here which requirements are necessary for the image processing unit 10. The prominent objects 25, 26, which in this case are a building 26 shown on the right edge of the street and a traffic sign 25 situated on the left edge of the street can be recognized in two consecutive positions. It is therefore demonstrated that change in prominent objects 25, 26, like building 26 and sign 25 and the street layout 21 relative to them are necessary for image processing. The distance between such prominent objects 25, 26 can be identified and processed in image processing unit 10 both in terms of time and movement direction.

In this way the direction of movement 27 and therefore the covered path 27 [sic] is recorded via the image processing unit 10. If now, deviating from the depiction in FIG. 4 a prominent object 25, 26, for example, the building 26 situated on the right edge of the roadway, is shifted in its direction of movement 27 and therefore into detection of its geometric change to one side of the camera image 20, the image processing unit 10 will therefore identify a direction change.

The frequency of the camera images 20 recorded for evaluation is also of great significance, since at high travel speeds the distances of the prominent objects 25, 26 are correspondingly larger with the same image recording sequence. Conclusions concerning the travel speed can therefore also be drawn from the objects 25, 26.

During image processing, with reference to prominent objects 25, 26 identical or very similar features from one image to the next image are sought. The changes from image to image are generally geometric changes, which, for example, in a camera image sequence of 30 images per second and integration of all smaller changes lead to a larger change to a direction vector 30 of the actual movement of vehicle 1. This large change describes the instantaneous motion or speed vector 30.

During a lateral change in prominent objects 25, 26 the image processing unit 10 will identify a direction change and therefore a direction vector 30. This direction vector 30 is the integration of geometric changes during a lateral shift from one image to the next recorded image.

During normal curved travel these lateral changes can be evaluated as slight changes. If an abrupt change in direction occurs, for example, a turn into another street, the direction vector 30 will experience an extremely large change to the side because of the lateral geometric changes of the prominent objects 25, 26.

It is therefore possible by means of changes of prominent objects 25, 26 situated essentially in front of vehicle 1 to recognize a change in direction and to determine this change in direction as the calculation result of an image processing unit 10 from a motion vector/speed vector 30 with a corresponding variable direction. This occurs in the described manner for an area (street layout 21) situated mostly in front of vehicle 1. According to the travel speed of vehicle 1 it is naturally necessary that the area situated in front of vehicle 1 be detected farther out front at higher speed. At lower speeds a smaller area is then naturally detected accordingly. A smaller area is detected accordingly [sic]. A representation of the motion vector 30, as established in this example during curved travel is imaged in FIG. 5 among others.

A simplified representation of the headlight system is shown in FIG. 6 in the form of a block diagram from image recording 11 through the optical sensor 5 up to adjustment of the front headlight 14. The optical sensor 5, here a camera, records the visual region situated in front of vehicle 1. The camera 5 is capable of furnishing, for example, 30 images per second to the image recording unit 11. As described with reference to FIGS. 3, 4 and 5, prominent objects 25, 26, the street layout 21 and the like are identified in the image recording unit 11. The same features that have changed from image to image are sought here. The image recording unit 11 sends the correspondingly processed images (prominent brightness jumps, prominent objects 25, 26 and the like) to evaluation unit 12. It combines these images with vehicle data, like speed of vehicle 1, wheel revolutions, steering angle data and the like, so that an anticipatory assertion concerning the subsequent street layout 21 and the changes in direction to be expected can be made.

The image recording unit 11 and the evaluation unit 12 form the image processing unit 10. After a planned change in direction, for example, a corresponding signal is sent by the image processing unit 10 to a light control device 13. This signal is evaluated by the light control device 13, which sends a corresponding control signal to the headlight 14. Adjustment motors are driven with the control signal. They pivot the headlight 14 in the direction of the travel direction change or align it so that an illumination range adjusted to the present speed and corresponding to the roadway layout 21 (desired change in travel direction) is set.

To explain the complex relations of image recording unit 11 and image evaluation unit 12 a flow chart of the entire image processing unit 10 is shown in FIG. 7 with the dependences relative to influences, starting from the camera image recording 11 to control of the headlight 14. It is apparent from the diagram that the environment-specific data are linked to the vehicle-specific data, like steering angle, speed. A reliable headlight regulation is guaranteed on this account.

The image in front of vehicle 1 is recorded by camera 5. Naturally in addition to optical camera systems, other systems can be used. For example, ultrasonic systems, radar systems or laser systems can be involved here. All these systems are suitable for recording measurement data for processing or for furnishing the appropriate data necessary for this. The data so recorded are environment-specific data, since they make assertions concerning the environment outside the vehicle.

In the next step, for example, edges 31 are detected from these data/images or other prominent objects 25, 26 identified. This procedure is repeated from image to image, in which the image data so processed are combined in a subsequent step to an object hypothesis 32. An attempt is made in this object hypothesis 32 to combine individual prominent points or edges with similar features from several consecutive images to an object. If an object hypothesis, for example, edge 22 was confirmed along the vehicle (FIG. 4) within an area from 0 to 2 m to the right of the vehicle over several images/measurements, an object classification 33 (FIG. 7) can occur, in this case as a roadway boundary/marking 35. Among other things, the street layout in front of the vehicle 39 can be derived from this and an additional area based on a curve 45 within the illumination area 48 activated if this recognized edge 22 (FIG. 4) suggests a right-bending street layout. Many different possibilities can result in this case. For example, it is possible that a curve with a large radius of curvature is to be traveled with high speed or an intersection is present with an opportunity to turn left or right.

These possibilities are identified and combined accordingly in the object classification step 33. This processing step leads to a number of object classes 34 to 38 then further processed to corresponding combined information and data.

For example, there is an object class 34 that records environmental conditions, like fog, rain, day or night. Another object class 35 mostly processes the street layout 21, as well as the corresponding edge conditions, for example, edge structure, whereas another object class 36 identifies all data and information concerning other traffic participants (vehicles traveling in front or oncoming vehicles). Obstacles on the roadway are recognized in object class 37. These can be, for example, lost objects or stopped vehicles/objects. In another object class 38 it is possible to identify hazardous objects on the edge of the roadway. Such hazardous objects, for example, can be vehicles or persons approaching from the side. All these object classes 34 to 38 are generated according to ordinary image processing algorithms and in all generally expected logical relations. Blocks 39 to 43 describe functions for the system according to the invention that can be derived from object classes 34 to 38. From the derived functions 39 to 43, as well as object classes 34, 36 the illumination areas 44 to 47 can be determined via a map according to the invention and combined to an illumination area 48. This then advantageously gives the illumination area marked 16 in FIG. 2 for the street scene depicted in FIG. 3.

These functional units 39 to 43 are capable of evaluating the information and data summarized in object classes 34 to 38 in detail and therefore according to the desired reaction. For example, traffic participants in front of the actual vehicle 1 could be identified in function 39, special situations in function 40, like intersections, or a driver wish in function 41 (selected travel direction display, speed) can be further specified. The function units 39 to 41 are determined among other things from object class 35. Object class 36 is assigned the function units 41 and 42. In function 42, for example, hazard situations before an impending collision are recognized. Function 42 is accordingly not only linked to object class 36 but also to object classes 37 and 38. In function 43 driving dynamic data, i.e., vehicle-specific data, like speed and steering angle are recorded and advantageously improve with additional data from the vehicle. All these functions 39 to 43, which are available in advantageous processing for the system according to the invention, are now advantageously assigned to light areas 44 to 47 via a set of characteristics.

For example, an area restriction 44 with reference to glare from oncoming vehicles is checked. The area restriction 44 is determined from object class 36. An additional area 45, which his linked to functions 39, 41, 43 permits additional light areas caused by typical edge conditions to be expected on the travel path. This can involve, for example, a travel path as shown in FIG. 3. Here an additional area 16 (FIG. 2) for curved travel is activated in addition to a legal minimum illumination area.

It is ensured in the base illumination area 46 that all data determined and evaluated thus far correspond to a legal minimum illumination area and illumination areas deviating from this therefore cannot be adjusted, for example overlapping area 15, 16 in FIG. 2.

Another additional area 47, which is linked to functions 40 and 42, permits special additional areas based on special situations, like the function 42 described previously. In this case identified hazard situations, like possible collisions, are considered. This can mean, for example, that objects lying on the roadway or objects coming onto the roadway from the side, for example, animals or pedestrians, are deliberately illuminated in order to warn the driver accordingly, even if these objects lie outside of the illumination area determined based on the traffic situation. The data of the image processing unit 10 processed concerning objects 34 to 38, functions 39 to 43 and areas 44 to 47 are combined in the unit 48 so that a desired illumination area is determined from all conditions that apply for the instantaneous situation. In this way the environment-specific and vehicle-specific data are linked to each other so that the necessary illumination area is determined, depending on the traffic situation and/or the environmental situation.

In order to avoid irritation or incorrect interpretations of other traffic participants (for example, confusion with flashers), changes should only occur slowly. The signals over a certain time are filtered or integrated (function 49). It is therefore possible to permit following of the illumination area not recognizable for the driver and other traffic participants. Old and new values are integrated according to the time behavior so that a clear signal image is generated.

In a subsequent step of conversion 50 the signals are processed so that any light fields 57 or optical elements or actuators 58 (FIG. 8) can be controlled. Following this conversion 50 control of the light control device 13 is prescribed. Here the corresponding signals for direct control of the actuators 58 or light fields 57 are conveyed, for example, in the form of timed currents directly to the headlight 14.

The method of controlling lamps 57, optical elements or actuators 58 is shown in detail in FIGS. 8 and 9.

In FIG. 8, for example, the signal furnished by the image processing unit 10 is processed in the light control device 13 so that subsequent power drivers 56 (power stages) permit direct control of the actuator 58 and/or direct control of lamps 57.

The use of power drivers 56 is necessary, since the data made available by the image processing unit 10 do not permit direct control of motors, actuators 58 or lamps 57. Higher currents and voltages are required for this than are ordinarily available in electronic evaluation and processing units. As is apparent in FIG. 8, parallel-connected actuators 58 can be controlled, which in turn permit pivoting of reflectors or entire lamp groups 57. Parallel with this pivot process it is possible that additional parallel-connected lamps 57 can be included for further lateral illumination via additional power drivers 56 or required for a change in illumination range.

A similar principle to that described in FIG. 8 is shown in FIG. 9. In this case the signals from the light control device 13 are conveyed to the light fields 57 via the parallel-connected power driver 56. These light fields 57 can be connected lamps 57 like LEDs, which are connected in series. A different area in front of the vehicle 1 or to the side of vehicle 1 can be illuminated according to switching on and switching off of such light fields 57.

With reference to the actuators 58, FIG. 10 shows the pivot drive of a light unit in a headlight 14. This is a schematic top view of a headlight 14 that has lamps 57 with corresponding optics 61 arranged in a center assembly, in which the lamps 57 and the corresponding optics 61 are arranged on a common lamp support 64. The light emerging here is emitted through the light disk 62 onto roadway 2.

During identification of a change in travel direction, after recording of images in the corresponding evaluated data in the image processing unit 10 a corresponding signal is sent to the light control device 13. This light control device 13 controls a servomotor depicted as in FIG. 10, which pivots the lamp support 64 around a pivot axis 63 according to the desired change in direction of travel via a push-pull rod 65 and a linkage 66. The complete unit as shown in FIG. 10 can be integrated fully within headlight 14. This is therefore a closed unit that need only be controlled via corresponding lines and bus systems from the image processing unit 10 and the light control unit 13.

The illumination areas are preferably according to the current ECE regulations.

Evaluation of sensor signals is known, for example, images by image processing or so-called machine vision. The layout and evaluation of RADAR or LIDAR sensors is also known. Standard software in which software code for an image evaluation/image processing can be generated automatically is also known.

The headlight system has at least one sensor, for example, a CMOS camera chip with optics and at least one evaluation unit (computer), preferably a digital signal processor on which data evaluation, preferably image evaluation occurs. From the determined data (street layout, etc.) the ideal illumination area, preferably according to ECE guidelines is calculated and set via the actuators. In addition the outer circuitry (voltage processing/voltage supply, power drivers for the actuators, etc.) occurs as shown schematically in FIGS. 8 and 9. The function is completely implemented in software (FIG. 7).

1. Headlight system for vehicles, preferably motor vehicles, with at least one adjustable headlight, with a device to record the road layout, which contains at least one imaging sensor with an image processing device and a light control device and via the images/data determined by the imaging sensor sends signals by means of the image processing device and to the light control device for actuators or lamps of the headlight to change the direction of the emitting beams [sic], characterized by the fact that the image processing device (10) from the images/data determined by the imaging sensor (5) generates at least one signal, which permits a prediction of the road layout (21) and which can be fed to the light control device (13), which sends signals to the actuators (58) for an anticipatory direction change of the emitting light beams of the headlight (14).

2. Headlight system, especially according to claim 1, characterized by the fact that environmental images/data recorded by the image processing device (10) are linked to vehicle-specific data and a signal is generated which sends signals to the actuators (58) for an anticipatory direction change of the emitting light beams of the headlight (14).

3. Headlight system according to claim 1 or 2, characterized by the fact that the images/data determined by the imaging sensor (5) are converted into light and dark edge contours by the image processing device (10).

4. Headlight system according to one of the claims 1 to 3, characterized by the fact that the images/data determined by the imaging sensor (5) contain prominent and statically defined objects (25, 26).

5. Headlight system according to one of the claims 1 to 4, characterized by the fact that the images/data determined by the imaging sensor (5) are converted by the image processing device (10) into a motion vector (30).

6. Headlight system according to one of the claims 1 to 5, characterized by the fact that the images/data determined by the imaging sensor (5) are converted by the image processing device (10) into a velocity vector (30).

7. Headlight system according to one of the claims 1 to 6, characterized by the fact that the images/data determined by the imaging sensor (5) through the image processing device (10) cause an illumination (15, 16) variable in range and width.

8. Headlight system according to claim 7, characterized by the fact that the illumination (15, 16) is variable in its range and/or its width as a function of the vehicle speed.

9. Headlight system according to claim 7, characterized by the fact that the illumination (15, 16) is variable in its range and/or its width as a function of environmental conditions, like fog, rain, snow, day or night.

10. Headlight system according to claim 7, characterized by the fact that the illumination (15, 16) is variable in its range and/or its width as a function of the road layout (21), like curves, turns or intersections.

11. Headlight system according to claim 7, characterized by the fact that the illumination (15, 16) is variable in its range and/or its width as a function of edge structures like the road edge (22, 23), construction (26), traffic signs (25) and trees.

12. Headlight system according to claim 7, characterized by the fact that the illumination (15, 16) is variable in its range and/or its width as a function of obstacles on the roadway that are larger than 5 cm in dimension.

13. Headlight system according to claim 7, characterized by the fact that the illumination (15, 16) is variable in its range and/or its width as a function of hazardous objects on the edge of the roadway, like objects moving across the direction of travel.

14. Headlight system according to one of the claims 1 to 13, characterized by the fact that the imaging sensor (5) is an optical camera.

15. Headlight system according to one of the claims 1 to 13, characterized by the fact that the imaging sensor (5) is a laser scanning device.

16. Headlight system according to one of the claims 1 to 13, characterized by the fact that the imaging sensor (5) is an ultrasonic scanning device.

17. Headlight system according to one of the claims 1 to 13, characterized by the fact that the imaging sensor (5) is a radar scanning device.

18. Headlight system according to one of the claims 1 to 17, characterized by the fact that the imaging sensor (5) is mounted in the vehicle interior and in the edge area of the windshield.

19. Headlight system according to one of the claims 1 to 17, characterized by the fact that the imaging sensor (5) is integrated in the inside mirror or connected directly to the inside mirror.

20. Headlight system according to one of the claims 1 to 17, characterized by the fact that the imaging sensor (5) is accommodated in an A pillar or in the upper front roof edge area.

21. Headlight system according to one of the claims 1 to 17, characterized by the fact that the imaging sensor (5) is accommodated in the headlight system or in the vicinity of the headlight system, for example, in the radiator grill, in the bumper, etc.

22. Headlight system according to one of the claims 1 to 21, characterized by the fact that the detecting range (6) of the imaging sensor (5) is dependent in its range and/or its width on the speed of the vehicle (1).

23. Headlight system according to one of the claims 1 to 22, characterized by the fact that the detecting range (6) of the imaging sensor (5) is dependent in its range and/or its width on the direction of motion and speed of the vehicle (1).

24. Headlight system according to one of the claims 1 to 23, characterized by the fact that the detecting range (6) of the imaging sensor (5) is dependent in its range and/or its width on surrounding conditions, like fog, rain, snow, day or night.

25. Headlight system according to one of the claims 1 to 24, characterized by the fact that the detecting range (6) of the imaging sensor (5) is dependent in its range and/or its width on the road layout (21), like curves, bends or intersections.

26. Headlight system according to one of the claims 1 to 25, characterized by the fact that the detecting range (6) of the imaging sensor (5) is dependent in its range and/or its width on edge structures, like road edges (22, 23) or construction (26) (prominent objects).

27. Headlight system according to one of the claims 1 to 26, characterized by the fact that the detecting range (6) of the imaging sensor (5) is dependent in its range and/or its width on obstacles on the roadway that are larger in dimension than 5 cm.

28. Headlight system according to one of the claims 1 to 27, characterized by the fact that the detecting range (6) of the imaging sensor (5) is dependent in its range and/or its width on hazardous objects on the road edge (22, 23), like objects moving across the direction of travel.

29. Headlight system according to one of the claims 1 to 28, characterized by the fact that illumination (15, 16) variable in range and/or width occurs by pivoting the headlight (14).

30. Headlight system according to one of the claims 1 to 28, characterized by the fact that illumination (15, 16) variable in range and/or width occurs by pivoting assemblies of the headlight (14), like reflectors, mirrors or lamps (57).

31. Headlight system according to one of the claims 1 to 28, characterized by the fact that illumination (15, 16) variable in range and/or width occurs by stepless or stepped switching on or switching off of lamps (57).

32. Headlight system according to one of the claims 1 to 28, characterized by the fact that illumination (15, 16) variable in range and/or width occurs by switching on or switching off additional headlights (14).
